(19) United States
(12) Patent Application Publication
(10) Pub. No.: US 2015/0329077 A1
(43) Pub. Date: Nov. 19, 2015

(54) CONTACT ACTUATOR FOR A MOTOR VEHICLE

(71) Applicant: U-SHIN FRANCE SAS, Creteil (FR)

(72) Inventors: Alix Della Fiorentina, Creteil (FR); Patrice Poggi, Creteil (FR)

(73) Assignee: U-SHIN FRANCE SAS, Creteil (FR)

(21) Appl. No.: 14/653,575

(22) PCT Filed: Dec. 18, 2013
(86) PCT No.: PCT/EP2013/077170

§ 371 Date: Jun. 18, 2015

(30) Foreign Application Priority Data
Dec. 21, 2012 (EP) 12199260.6

(51) Int. Cl. B60R 25/021; E05B 85/06

(52) U.S. Cl. CPC B60R 25/021; E05B 85/06

(57) ABSTRACT

The invention relates to a contact actuator comprising: a casing (102); a barrel intended to pivot about an axis A1 in relation to the casing (102); a pull knob intended to move between a locking position in which the steering column is locked and an unlocking position in which the steering column is unlocked; and a handle comprising (i) a rod (108) extending along axis A1, the first end of which is inserted into the barrel so as to slide therein, said rod (108) being secured to the barrel such as to rotate therewith about axis A1, and (ii) a head secured to a second end of the rod (108), by means of which the handle is intended to be gripped and manipulated. The casing (102) defines an internal space (302) in which the rod (108) extends and, in said internal space (302), the casing includes a longitudinal groove (304) parallel to axis A1. The rod (108) includes a lug (208) intended to move inside the longitudinal groove (304) when the rod (108) moves between its forward and rearward positions, said longitudinal groove (304) circumferentially blocking the lug (208) of the rod (108) such as to prevent the rotation of the handle about axis A1.

The present invention relates to an ignition actuator for a motor vehicle.

The use is known of an ignition actuator for a motor vehicle of the type comprising:
a casing,
a barrel intended to pivot about an axis A1 with respect to the casing,
a pull knob intended to move between a position of locking a steering column and a position of unlocking the steering column, and
a handle comprising:
   a rod extending along the axis A1, inserted in the barrel by a first end and intended to slide in said barrel between an advanced position in which the rod causes the possibility for the pull knob to pass from its unlocking position to its locking position, and a retracted position in which the rod prevents the pull knob from passing from its unlocking position to its locking position, the rod being constrained to rotate with the barrel about the axis A1, and
   a head fixed to a second end of the rod, by means of which the handle is intended to be gripped and manipulated.

In this known ignition actuator, the handle is an ignition key intended to be removed so that the user takes it away with him. The barrel is also provided with a tumbler preventing its rotation as long as the ignition key provided with the correct coding is not completely inserted. Thus the key is locked with respect to rotation by the barrel as long as it has not reached its retracted position.

However, it is in some cases desirable to provide the motor vehicle with a non-removable key in a simple manner, for example for hire cars. In this case, coding of the key is unnecessary. However, it is all the same desirable to keep the rotational locking of the key as long as it has not reached its retracted position.

In order at least partly to respond to this problem, an ignition actuator of the aforementioned type is proposed, characterised in that the casing defines an internal space in which the rod extends and has, in this internal space, a longitudinal groove parallel to the axis A1, and in that the rod has a lug intended to move in the longitudinal groove when the rod moves between its advanced position and its retracted position, the longitudinal groove circumferentially locking the lug of the rod so as to prevent rotation of the handle about the axis A1.

Optionally, the casing also has, in the internal space, a circumferential groove around the axis A1 crossing the longitudinal groove, in which the lug of the rod is intended to move when the rod, once it has arrived at its retracted position, is turned about the axis A1, the circumferential groove longitudinally locking the lug of the rod so as to prevent movement of the rod along the axis A1.

Optionally also, the rod has a groove inclined with respect to the axis A1 and formed in the rod, and the ignition actuator further comprises a sensor mounted on the barrel pivoting about an axis A3, the sensor having a pin inserted in the inclined groove so as to pivot the sensor between a first position in which the sensor enables the pull knob to move from its unlocked position to its locked position and a second position in which the sensor prevents the pull knob from moving from its unlocked position to its locked position, when the rod slides between its advanced position and its retracted position.

Optionally also, the rod has a broadened portion in which the inclined groove is formed.

Optionally also, the broadened portion has a flat in which the inclined groove is formed.

Optionally also, the casing has a front face, the rod has a first end inserted in the casing through the front face and a second end projecting from the front of the front face, to which the head is fixed, and the ignition actuator further comprises a stop preventing the rod emerging out of the casing from the front.

An example embodiment of the invention will now be described with reference to the accompanying drawings, among which:

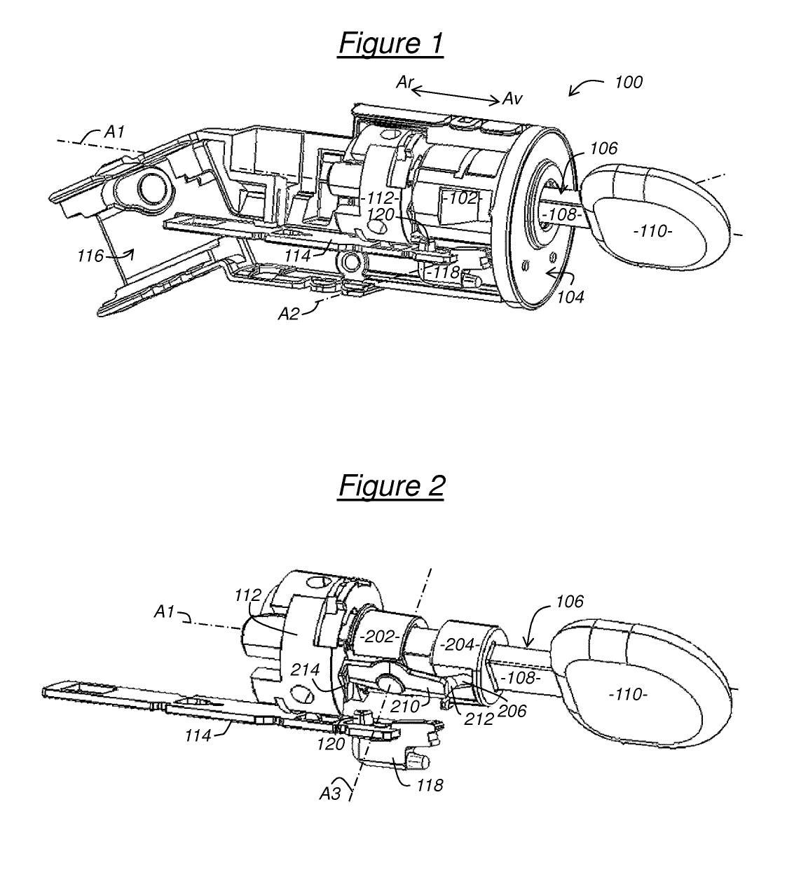

FIG. 1 is a three-dimensional view of an ignition actuator for a motor vehicle;

FIG. 2 is a three-dimensional view of the actuator in FIG. 1, with a casing removed;

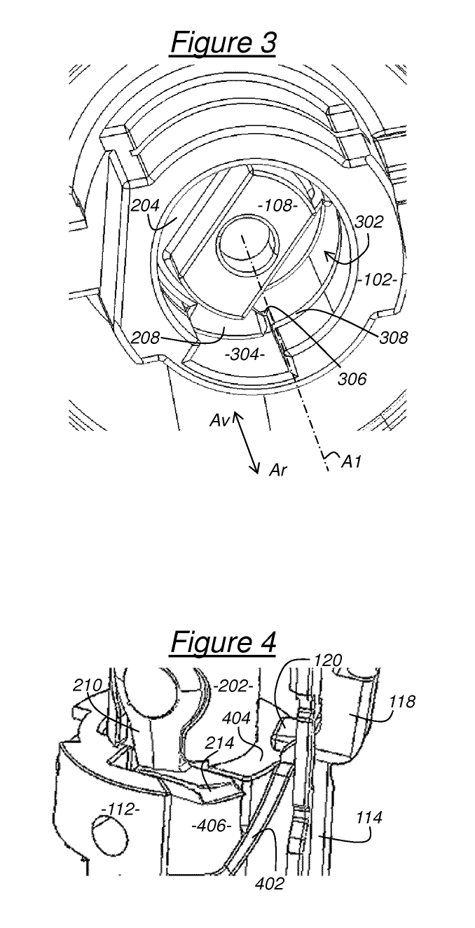

FIG. 3 is a three-dimensional view of the inside of the casing; and

FIG. 4 is a three-dimensional view of a part of the actuator.

With reference to FIG. 1, an ignition actuator for a motor vehicle 100 will now be described.

The actuator 100 comprises first of all a casing 102 having an external face 104 intended to be oriented towards the passenger compartment of the motor vehicle.

The actuator 100 further comprises a handle 106 in the form of a key. The handle 106 comprises first of all a rod 108 extending along an axis A1 and partly inserted in the casing 102 through its external face 104. The axis A1 defines a front-rear direction AV-AR, the front being in the direction of the external face 104, hereinafter referred to as the front face 104. The rod 108 thus has a front end projecting from the front face 104 of the casing 102, to which a flattened head 110 is fixed. The handle 106 is intended to be gripped and manipulated by this head 110.

The actuator 100 also comprises a camshaft 112 situated at the rear of the casing 102 in line with the axis A1. The camshaft 112 is intended to pivot about the axis A1 with respect to the casing 102.

The actuator 100 also comprises a pull knob 114 extending along the axis A1 and intended to slide parallel to this axis A1 with respect to the casing 102, between a rear position of locking a steering column and a front position of unlocking the steering column This steering column is not shown in the figures but lies in a housing 116, in which the pull knob 114 enters in the locking position and from which the pull knob 114 is released in the unlocking position.

The actuator 100 further comprises a rocker 118 mounted on the pull knob 114 so as to pivot on an axis A2 orthogonal to the axis A1. The rocker 118 has a finger 120 extending towards the axis A1.

With reference to FIG. 2, the actuator 100 also comprises a cylindrically shaped barrel 202 centred on the axis A1. The barrel 202 is intended to pivot about the axis A1 with respect to the casing 102 and constrained to rotate with the camshaft 112 about the axis A1 so as to drive it. The barrel 202 has an opening in which a rear end of the rod 108 is inserted. The rod 108 is intended to slide in the barrel 202 while being constrained to rotate with the latter about the axis A1 so as to rotate the barrel 202. The rod 108 has a broadened portion 204 situated at the front of the barrel 202, cylindrically shaped with a lateral flat and with a diameter corresponding to that of the barrel 202 so as to be a continuation thereof. A groove 206 inclined with respect to the axis A1 is provided in the flat on the broadened portion 204. Furthermore, the rod 108 has a lug 208 projecting radially from the cylindrical portion 304. In the example described, the lug 208 is in the form of a circumferential rib extending over the cylindrical portion 304.

The actuator 100 further comprises a sensor 210 mounted on the barrel 202 so as to pivot about an axis A3 transverse to the axis A1. The sensor 210 has an elongate shape and is mounted so as to pivot in its central part. The sensor 210 has, at one end, a pin 212 inserted in the inclined groove 206 of the handle 106 and, at another end, a lug 214.

With reference to FIG. 3, the casing 102 defines a cylindrical internal space 302 in which the rod 108, in particular the broadened portion 204, extends. The casing 102 has, in this internal space 302, a longitudinal groove 304 parallel to the axis A1 and having a front edge 306. The casing 102 also has, still in the internal space 302, a circumferential groove 308 extending about the axis A1 and crossing the longitudinal groove 304. The lug 208 is intended to successively advance in the grooves 304 and 308, as will be explained below.

With reference to FIG. 4, the camshaft 112 has a ramp 402 extending helicoidally about the axis A1, and a step 404 at which the ramp 402 terminates, the step 404 partly bordering the ramp 402 on the axis A1 side. The camshaft 112 is also provided with a longitudinal return groove 406 connecting the step 404 to the bottom of the ramp 402.

The functioning of the actuator 100 will now be described.

At the start, the handle 106 is in a position advanced towards the vehicle passenger compartment. The rod 108 of the handle 106 cannot be brought out of the casing 102 from the front since the lug 208 of the handle 106 abuts against the front edge 306 on the longitudinal groove 304 of the casing 102, as can be seen in FIG. 3.

Furthermore, the longitudinal groove 304 prevents a circumferential movement of the lug 208 and therefore rotation of the handle 106. The pull knob 114 is in its rear position of locking the steering column The rocker 118 is in a released position, so that its finger 120 rests on the bottom of the ramp 402. The sensor 210 is also in a released position in which its lug 214 is released from the return groove 406.

The user then pushes on the handle 106 so as to slide it towards the rear as far as a retracted position. The lug 208 of the handle 106 then advances in the longitudinal groove 304 of the casing 102, said groove preventing a circumferential movement of the lug 208 and therefore rotation of the handle 106. During this sliding, the pin 212 of the sensor 210 is driven by the groove 206 so as to pivot the sensor 210 until its lug 214 obstructs the return groove 406, as shown in FIG. 4.

The user then turns the handle 106 to a turned position. The lug 208 of the handle 106 then moves in the circumferential groove 308 of the casing 102, said groove preventing the forward or backward sliding of the rod 108 and therefore of the handle 106. The rod 108 rotates the whole of the barrel 202 and camshaft 112. When the camshaft 112 rotates, the finger 120 of the rocker 118 slides on the ramp 402 and drives the pull knob 114 forwards until the latter reaches a position of unlocking the steering column. The finger 120 of the rocker 118 then reaches the step 404. Return means (not shown) then move the rocker 118 into a tilted position (illustrated in FIG. 4) such that, when the user once again turns the handle 106 so as to drive the barrel 202 and camshaft 112, the finger 120 of the rocker 118 slides not on the ramp 402 but on the step 404 alongside the ramp 402 and on the lug 214 of the sensor 210 obstructing the return groove 406. Thus the lug 214 of the sensor 210 prevents the finger 120 of the rocker 118 from following the return groove 406, which would have enabled the pull knob 114 to return to the rear position of locking the steering column

The user then returns the groove 206 of the rod 108 into the non-turned position, that is to say so that the lug 208 of the rod 108 is situated in the longitudinal groove 304 of the casing 102. In this position, the finger 120 of the rocker 118 is in abutment against the lug 214 of the sensor 210, which prevents it from following the return groove 406.

The user then pulls the handle 106 forwards in order to bring it from the retracted position to the advanced position. During the sliding, the inclined groove 206 of the rod 108 moves the pin 212 of the sensor 210 so as to pivot the sensor 210 so that the lug 214 of the sensor 210 is released from the return groove 406. Since the finger 120 of the rocker 118 is no longer locked, the finger 120 advances in the return groove until it reaches the bottom of the ramp 402, the pull knob 114 returns into the rear position of locking the steering column and the rocker 118 returns to the released position.

The invention is not limited to the example embodiment described above but on the contrary is defined, by the accompanying claims, the scope of which extends to all alternative modifications that can be conceived from the general knowledge of a person skilled in the art.

1. A ignition actuator for a motor vehicle, comprising:
a casing;
a barrel intended to pivot about an axis with respect to the casing;
a pull knob intended to move between a position of locking a steering column and a position of unlocking the steering column; and
a handle comprising:
a rod extending along the axis, inserted in the barrel by a first end and intended to slide in said barrel between an advanced position in which the rod causes the possibility for the pull knob to pass from its unlocking position to its locking position, and a retracted position in which the rod prevents the pull knob from passing from its unlocking position to its locking position, the rod being constrained to rotate with the barrel about the axis, and
a head fixed to a second end of the rod, by which the handle is intended to be gripped and manipulated,
wherein the casing defines an internal space in which the rod extends and has, in this internal space, a longitudinal groove parallel to the axis, and in that the rod has a lug intended to move in the longitudinal groove when the rod moves between its advanced position and its retracted position, the longitudinal groove circumferentially locking the lug of the rod so as to prevent rotation of the handle about the axis.

2. The ignition actuator according to claim 1, in which the casing also has, in the internal space, a circumferential groove around the axis crossing the longitudinal groove, in which the lug of the rod is intended to move when the rod, once it has arrived at its retracted position, is turned about the axis, the circumferential groove longitudinally locking the lug of the rod so as to prevent movement of the rod along the axis.

3. The ignition actuator according to claim 1, in which the rod has:
a groove inclined with respect to the axis and formed in the rod, and further comprising:
a sensor mounted on the barrel pivoting about another axis, the sensor having a pin inserted in the inclined groove so as to pivot the sensor between a first position in which the sensor enables the pull knob to move from its unlocking position to its locking position and a second position in which the sensor prevents the pull knob from moving from its unlocking position to its locking position, when the rod slides between its advanced position and its retracted position.

4. The ignition actuator according to claim 3, in which the rod has a broadened portion in which the inclined groove is formed.

5. The ignition actuator according to claim 4, in which the broadened portion has a flat in which the inclined groove is formed.

6. The ignition actuator according to claim 1, in which the casing has a front face, in which the rod has a first end inserted in the casing through the front face and a second end projecting from the front of the front face, to which the head is fixed, and further comprising:
a stop preventing the rod emerging out of the casing through the front.
